(19) United States
(12) Patent Application Publication
(10) Pub. No.: US 2025/0372306 A1
(43) Pub. Date: Dec. 4, 2025

(54) MULTILAYER CERAMIC ELECTRONIC COMPONENT AND METHOD OF MANUFACTURING THE SAME

(71) Applicant: TAIYO YUDEN CO., LTD., Tokyo (JP)

(72) Inventors: Kenji SAITO, Tokyo (JP); Katsunosuke HAGA, Tokyo (JP); Hiroaki UENISHI, Tokyo (JP); Satoshi KOBAYASHI, Tokyo (JP)

(73) Assignee: TAIYO YUDEN CO., LTD., Tokyo (JP)

(21) Appl. No.: 19/303,781

(22) Filed: Aug. 19, 2025

Related U.S. Application Data
(63) Continuation of application No. PCT/JP2024/001059, filed on Jan. 17, 2024.

(30) Foreign Application Priority Data
Feb. 22, 2023 (JP) 2023-026565

(51) Int. Cl. H01G 4/232; H01G 4/248; H01G 4/30; H01G 13/00

(52) U.S. Cl. CPC H01G 4/2325; H01G 4/248; H01G 4/30; H01G 13/006

(57) ABSTRACT

A multilayer ceramic electronic component includes a multilayer body having a substantially rectangular parallelepiped shape and including a plurality of internal electrode layers and a plurality of dielectric layers laminated on each other, the plurality of internal electrode layers being led out to a pair of end surfaces facing each other, a pair of end surface electrode layers covering the pair of end surfaces and extending from the pair of end surfaces to a pair of corner portions between the pair of end surfaces and four surfaces other than the pair of end surfaces among six surfaces of the multilayer body, and a peripheral surface electrode layer extending from end portions, in the substantially perpendicular direction, of the four surfaces other than the pair of end surfaces among the six surfaces of the multilayer body to the corner portions and covering the end surface electrode layers at the corner portions.

### CROSS-REFERENCE TO RELATED APPLICATION

This application is based upon and claims the benefit of priority of the prior International Patent Application No. PCT/JP2024/001059, filed on Jan. 17, 2024, which claims the benefits of priorities of Japanese Patent Application No. 2023-026565 filed on Feb. 22, 2023, the entire contents of which are incorporated herein by reference.

### FIELD

A certain aspect of the present disclosure relates to a multilayer ceramic electronic component and a method of manufacturing a multilayer ceramic electronic component.

### BACKGROUND

In order to improve the moisture resistance of ceramic electronic components such as multilayer ceramic capacitors and to suppress the penetration of plating solutions, it is required to sufficiently cover the corners of the multilayer body with the base layers of the outer electrodes to ensure reliability. In this regard, for example, Japanese Unexamined Patent Application Publication No. 2013-149939 discloses a technique of securing the thickness of the external electrode at a corner portion by reducing a deviation of the thickness of the external electrode.

### SUMMARY OF THE INVENTION

(1) According to a first aspect of the present disclosure, there is provided a multilayer ceramic electronic component including: a multilayer body that has a substantially rectangular parallelepiped shape and includes a plurality of internal electrode layers and a plurality of dielectric layers laminated on each other, the plurality of internal electrode layers being led out to a pair of end surfaces facing each other in a direction substantially orthogonal to a lamination direction of the plurality of internal electrode layers and the plurality of dielectric layers; a pair of end surface electrode layers that covers the pair of end surfaces so as to be connected to the plurality of internal electrode layers and extends from the pair of end surfaces to a pair of corner portions between the pair of end surfaces and four surfaces other than the pair of end surfaces among six surfaces of the multilayer body; and a peripheral surface electrode layer that extends from end portions, in the substantially perpendicular direction, of the four surfaces other than the pair of end surfaces among the six surfaces of the multilayer body to the corner portions and covers the end surface electrode layers at the corner portions.
(2) In the multilayer ceramic electronic component of the above-mentioned (1), the peripheral surface electrode layer may have a higher glass component content than the end surface electrode layer.
(3) In the multilayer ceramic electronic component of the above-mentioned (1) or (2), the end surface electrode layer may contain nickel as a main component, and the peripheral surface electrode layer may contain copper as a main component.
(4) In the multilayer ceramic electronic component of the above-mentioned (1) or (2), the end surface electrode layer and the peripheral surface electrode layer may contain copper as a main component.
(5) In the multilayer ceramic electronic component of the above-mentioned (1) or (2), in a cross-sectional view of the multilayer body along the lamination direction and the substantially orthogonal direction, a thickness of a central portion of the end surface electrode layer in the lamination direction may be equal to or less than a maximum value of a thickness of the end surface electrode layer and the peripheral surface electrode layer overlapping each other on the corner portion.
(6) According to a second aspect of the present disclosure, there is provided a method of manufacturing a multilayer ceramic electronic component, including: forming a multilayer body having a substantially rectangular parallelepiped shape and including a plurality of internal electrode layers and a plurality of dielectric layers laminated on each other, the plurality of internal electrode layers being alternately led out along a lamination direction to a pair of end surfaces facing each other; forming a pair of end surface electrode layers connected to the plurality of internal electrode layers by attaching a metal sheet from the pair of end surfaces to a pair of corner portions between the pair of end surfaces and four surfaces other than the pair of end surfaces among six surfaces of the multilayer body; and forming a peripheral surface electrode layer by applying a conductive paste to the multilayer body such that the conductive paste extends from end portions, in the substantially orthogonal direction, of the four surfaces other than the pair of end surfaces among the six surfaces of the multilayer body to the corner portions and covers the end surface electrode layers at the corner portions.
(7) In the method of manufacturing the multilayer ceramic electronic component of the above-mentioned (6), the metal sheet may contain nickel as a main component, and the conductive paste may contain copper as a main component.
(8) In the method of manufacturing the multilayer ceramic electronic component of the above-mentioned (6), the metal sheet and the conductive paste may contain copper as a main component.
(9) In the method of manufacturing the multilayer ceramic electronic component of the above-mentioned (8), the forming of the pair of end surface electrode layers may include attaching and firing the metal sheet, and the forming of the peripheral surface electrode layer may include applying the conductive paste to the multilayer body and firing the conductive paste.

### BRIEF DESCRIPTION OF THE DRAWINGS

FIG. 1 is a perspective view illustrating an example of a multilayer ceramic capacitor.

FIG. 2 is a cross-sectional view of the multilayer ceramic capacitor taken along a line A-A in FIG. 1.

FIG. 3 is a cross-sectional view of the multilayer ceramic capacitor taken along a line B-B in FIG. 2.

FIG. 4 is a cross-sectional view of the multilayer ceramic capacitor taken along line C-C in FIG. 2.

FIG. 5 is a cross-sectional view illustrating an example of the thickness of the external electrode at a corner portion on an upper surface and an end surface side of a laminate.

FIG. 6 is a flowchart illustrating an example of a manufacturing process of a multilayer ceramic capacitor.

FIG. 7 is a plan view illustrating an example of a green sheet forming step, an internal electrode forming step, and a laminating and pressure-bonding step.

FIG. 8 is a side view illustrating an example of an end surface electrode forming step when an end surface of the laminate is viewed from the front.

FIG. 9 is a side view illustrating an example of the end surface electrode forming step when the end surface of the laminate is viewed from the front.

FIG. 10 is a side view illustrating an example of the end surface electrode forming step when the end surface of the laminate is viewed from the front.

FIG. 11 is a plan view illustrating an example of a peripheral surface electrode forming step by a dipping method in a side view of the laminate.

FIG. 12 is a plan view illustrating an example of the peripheral surface electrode forming step by the dipping method in a side view of the laminate.

### DETAILED DESCRIPTION

However, it is difficult to maintain a sufficient thickness of a base layer at the corner portion in the process of applying the conductive metal paste, sintering, and plating. Therefore, a discontinuous portion is generated in the base layer, and there is a possibility that sufficient reliability might not be secured.

In addition, when the thickness of not only the corner portion but also the entire external electrode increases, the size of the multilayer body needs to be reduced in order to, for example, obtain a multilayer ceramic capacitor having a predetermined size. This might cause the capacitance of the multilayer ceramic capacitor to be insufficient.

An object of the present disclosure is to provide a multilayer ceramic electronic component that is able to improve capacitance while ensuring reliability, and a method of manufacturing the same.

### Embodiment

### (Configuration of Multilayer Ceramic Capacitor)

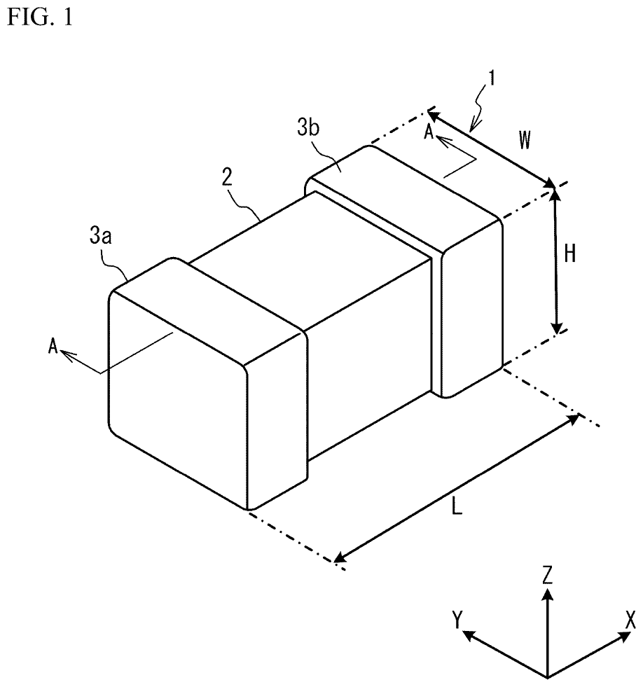

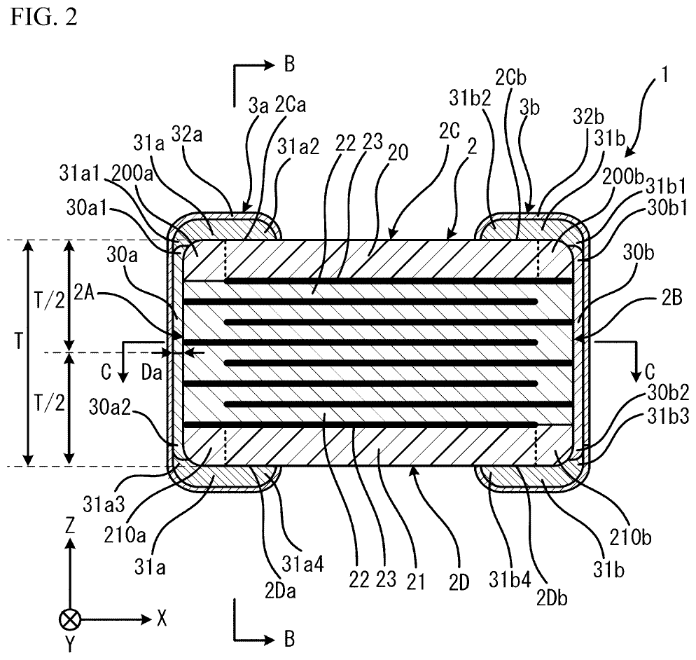

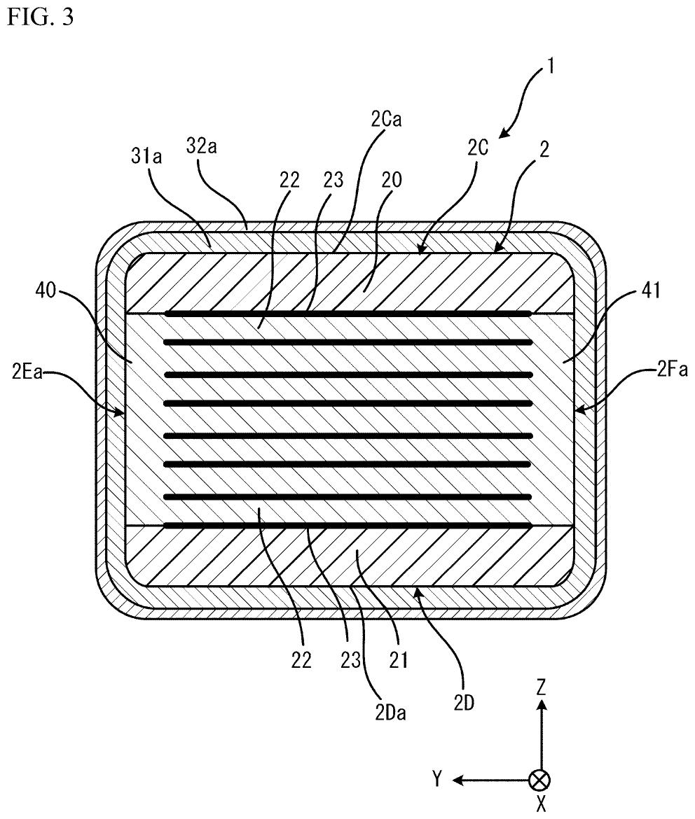

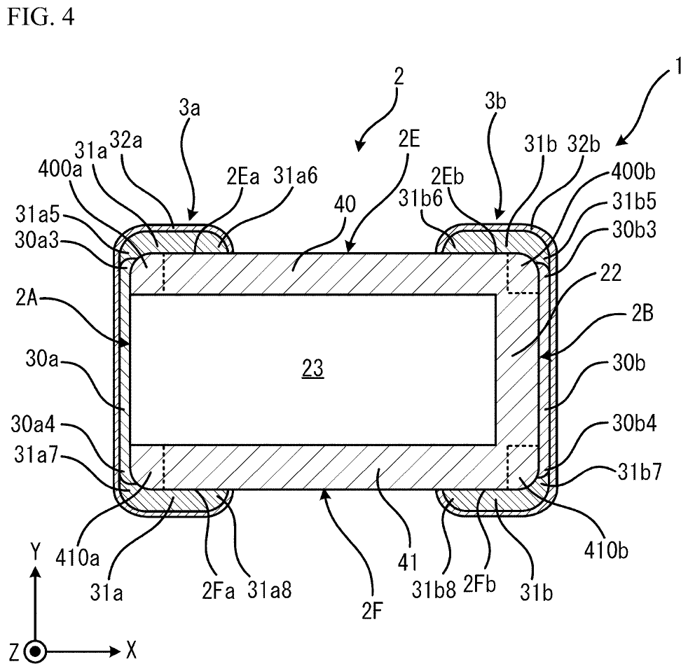

FIG. 1 is a perspective view illustrating an example of a multilayer ceramic capacitor 1. FIG. 2 is a cross-sectional view of the multilayer ceramic capacitor 1 taken along a line A-A in FIG. 1. FIG. 3 is a cross-sectional view of the multilayer ceramic capacitor 1 taken along a line B-B in FIG. 2. FIG. 4 is a cross-sectional view of the multilayer ceramic capacitor 1 taken along line C-C in FIG. 2.

The multilayer ceramic capacitor 1 is an example of a multilayer ceramic electronic component. Other examples of the multilayer ceramic electronic component include a multilayer ceramic varistor and a multilayer ceramic thermistor, and in the present embodiment, a multilayer ceramic capacitor is illustrated as a representative example thereof. The multilayer ceramic capacitor 1 includes a multilayer body 2 having a substantially rectangular parallelepiped shape, and external electrodes 3a and 3b provided on a pair of end surfaces 2A and 2B of the multilayer body 2 facing each other.

In FIGS. 1 to 4, an X direction, a Y direction, and a Z direction orthogonal to each other are illustrated. The X direction is a length (L) direction of the multilayer ceramic capacitor 1, and coincides with a direction in which the pair of end surfaces 2A and 2B of the multilayer body 2 face each other. The Y direction is a widthwise (W) direction of the multilayer ceramic capacitor 1, and coincides with a direction in which a pair of side surfaces 2E and 2F of the multilayer body 2 face each other. The Z direction is a height (H) direction of the multilayer ceramic capacitor 1, and coincided with a direction in which an upper surface 2C and a lower surface 2D of the multilayer body 2 face each other and a lamination direction of the multilayer ceramic capacitor 1. The X direction is an example of a direction substantially orthogonal to the lamination direction.

The multilayer body 2 includes the upper surface 2C, the lower surface 2D, the pair of end surface 2A and 2B, the pair of side surfaces 2E and 2F, and corner portions 200a, 210a, 200b, 210b, 400a, 410a, 400b, and 410b. The upper surface 2C and the lower surface 2D are substantially flat surfaces facing each other, the pair of end surface 2A and 2B are substantially flat surfaces facing each other, and the pair of side surfaces 2E and 2F are substantially flat surfaces facing each other. Additionally, the upper surface 2C and the lower surface 2D are adjacent to the pair of end surface 2A and 2B, and are examples of a surface substantially orthogonal to the lamination direction.

The multilayer body 2 has a multilayer structure in which dielectric layers 22 including a ceramic material functioning as a dielectric and internal electrode layers 23 are alternately laminated, and a pair of cover layers 20 and 21 are laminated so as to interpose the dielectric layers 22 and the internal electrode layers 23 therebetween from both sides in the lamination direction. A portion in which the dielectric layers 22 and the internal electrode layers 23 are alternately laminated may be referred to as a “capacitance portion layer”. The cover layers 20 and 21 interpose the capacitance portion layer therebetween from both sides in the lamination direction. Side margins 40 and 41 are provided on both sides of the internal electrode layers 23 and the dielectric layers 22 in the width direction. The side margins 40 and 41 interpose the capacitance portion layer therebetween from both sides in the width direction.

As illustrated in FIG. 2, the corner portion 200a is a curved portion between the end surface 2A and the upper surface 2C. The corner portion 200b is a curved portion between the end surface 2B and the upper surface 2C. The corner portion 210a is a curved portion between the end surface 2A and the lower surface 2D. The corner portion 210b is a curved portion between the end surface 2B and the lower surface 2D. The corner portions 200a and 200b are provided at respective ends of the cover layer 20 in the length direction thereof, and the corner portions 210a and 210b are provided at respective ends of the cover layer 21 in the length direction thereof. The corner portions 200a, 200b, 210a, and 210b are referred to as, for example, “edge portions”. The dotted lines indicate the boundary between the corner portions 200a and 200b each having a curved shape and the upper surface 2C having a substantially flat shape, and the boundary between the corner portions 210a and 210b each having a curbed shape and the lower surface 2D having a substantially flat shape.

Further, as illustrated in FIG. 4, the corner portion 400a is a curved portion between the end surface 2A and the side surface 2E. The corner portion 400b is a curved portion between the end surface 2B and the side surface 2E. The corner portion 410a is a curved portion between the end surface 2A and the side surface 2F. The corner portion 410b is a curved portion between the end surface 2B and the side surface 2F. The corner portions 400a and 400b are provided at respective ends of the side margin 40 in the length direction thereof, and the corner portions 410a and 410b are provided at respective ends of the side margin 41 in the length direction thereof. The dotted lines indicate the boundaries between the corner portions 400a and 400b each having a curved shape and the end surface 2B and the side surface 2E each having a substantially flat shape, and the boundaries between the corner portions 410a and 410b each having a curved shape and the end surface 2B and the side surface 2F each having a substantially flat shape.

The internal electrode layers 23 are opposed to each other with the dielectric layers 22 interposed therebetween in the lamination direction, and one ends thereof are alternately led out to the end surfaces 2A and 2B along the lamination direction. The internal electrode layers 23 are composed of a base metal such as Ni (nickel), Cu (copper), or Sn (tin) as a main material. A noble metal such as Pt (platinum), Pd (palladium), Ag (silver), or Au (gold), or an alloy containing these may be used as the internal electrode layer 23. The thickness of the internal electrode layer 23 is, for example, 0.3 to 1.3 (μm). The thickness of the internal electrode layer 23 is not limited to this, and may be, for example, 0.3 (μm) or less, or 0.05 to 0.3 (μm). Further, the thickness of the internal electrode layer 23 may be 1.3 (μm) or more, or may be 1.3 to 3.5 (μm).

The dielectric layer 22 includes, for example, a ceramic material having a perovskite structure represented by a general formula ABO₃ as a main phase. The perovskite structure includes ABO_{3-α} (α represents a minute number) that deviates from the stoichiometric composition. For example, as the ceramic material, at least one of BaTiO₃ (barium titanate), CaZrO₃ (calcium zirconate), CaTiO₃ (calcium titanate), SrTiO₃ (strontium titanate), MgTiO₃ (magnesium titanate), and Ba_{1-x-y}CaₓSr_{y}Ti_{1-z}Zr₂O₃ (0≤x≤1, 0≤y≤1, 0≤z≤1) forming a perovskite structure can be selected and used. Ba_{1-x-y}CaₓSr_{y}Ti_{1-z}Zr₂O₃ is barium strontium titanate, barium calcium titanate, barium zirconate, barium zirconate titanate, calcium zirconate titanate, barium calcium zirconate titanate, and the like. The thickness of the dielectric layer 22 is, for example, 0.3 to 4.0 (μm). The thickness of the dielectric layer 22 is not limited to this, and may be 0.3 (μm) or less, or may be 0.05 to 0.3 (μm). Further, the thickness of the dielectric layer 22 may be 4.0 (μm) or more, or may be 4.0 to 20.0 (μm).

The cover layers 20 and 21 and the side margins 40 and 41 are also formed using a ceramic material as a main component, similarly to the dielectric layers 22.

The external electrodes 3a and 3b is provided in the end surfaces 2A and 2B of the multilayer body 2 facing each other in the length direction of the multilayer ceramic capacitor 1, respectively. The external electrodes 3a and 3b extend to the upper surface 2C, the lower surface 2D, and the side surfaces 2E and 2F. However, the external electrodes 3a and 3b are separated from each other on the surfaces of the upper surface 2C, the lower surface 2D, and the side surfaces 2E and 2F.

The external electrode 3a includes an end surface electrode layer 30a, a peripheral surface electrode layer 31a, and a plating layer 32a, and the external electrode 3b includes an end surface electrode 30b, a peripheral surface electrode layer 31b, and plating layer 32b.

The end surface electrode layer 30a covers the end surface 2A so as to be electrically connected to the internal electrode layers 23 drawn to the end surface 2A. As illustrated in FIG. 2, the end surface electrode layer 30a extends from the end surface 2A to the corner portions 200a and 210a. Therefore, both of end portions 30al and 30a2 of the end surface electrode layer 30a in the lamination direction are located on the corner portions 200a and 210a, respectively. As illustrated in FIG. 4, the end surface electrode layer 30a extends from the end surface 2A to the corner portions 400a and 410a. Therefore, both of end portions 30a3 and 30a4 of the end surface electrode layer 30a in the widthwise direction are located on the corner portions 400a and 410a, respectively.

The end surface electrode layer 30b covers the end surface 2B so as to be electrically connected to the internal electrode layers 23 drawn out to the end surface 2B. As illustrated in FIG. 2, the end surface electrode layer 30b extends from the end surface 2B to the corner portions 200b and 210b. Therefore, both of end surfaces 30b1 and 30b2 of the end surface electrode layer 30b1 in the lamination direction are located on the corner portions 200b and 210b, respectively. As illustrated in FIG. 4, the end surface electrode layer 30b extends from the end surface 2B to the corner portions 400b and 410b. Therefore, the both of the end portions 30b3 and 30b4 of the end surface electrode layer 30b3 in the widthwise direction are located on the corner portions 400b and 410b, respectively.

As described above, the end surface electrode layer 30a is provided from the end surface 2A to the corner portions 200a, 210a, 400a, and 410a adjacent to the end surface 2A. The end surface electrode layer 30b is provided from the end surface 2B to the corner portions 200b, 210b, 400b, and 410b adjacent to the end surface 2B. The end surface electrode layers 30a and 30b are mainly composed of, for example, nickel, but may be mainly composed of copper.

As illustrated in FIG. 3, the peripheral surface electrode layer 31a is continuously provided on the side surfaces 2E and 2F, the upper surface 2C, and the lower surface 2D so as to surround the multilayer body 2 in a cross-sectional view along the lamination direction and the widthwise direction. Similarly to the peripheral surface electrode layer 31a, the peripheral surface electrode layer 31b is continuously provided on the side surfaces 2E and 2F, the upper surface 2C, and the lower surface 2D so as to surround the multilayer body 2. The peripheral surface electrode layers 31a and 31b are mainly composed of, for example, copper.

As illustrated in FIG. 2, on the upper surface 2C, the peripheral surface electrode layer 31a extends to the corner portion 200a from an end portion 2Ca in the length direction of the upper surface 2C. In the length direction, an end portion 31al of the peripheral surface electrode layer 31a is located on the corner portion 200a, and an end portion 31a2 of the peripheral surface electrode layer 31a is located on the end portion 2Ca, in the length direction, of the upper surface 2C. The peripheral surface electrode layer 31a covers the end surface electrode layer 30a in the corner portion 200a.

On the lower surface 2D, the peripheral surface electrode layer 31a extends to the corner portion 210a from an end portion 2Da, in the length direction, of the lower surface 2D. In the length direction, an end portion 31a3 of the peripheral surface electrode layer 31a is located on the corner portion 210a, and an end portion 31a4 of the peripheral surface electrode layer 31a is located on the end portion 2Da, in the length direction, of the lower surface 2D. The peripheral surface electrode layer 31a covers the end surface electrode layer 30a in the corner portion 210a.

Thus, the end portion 31al on the corner portion 200a of the peripheral surface electrode layer 31a overlaps the end portion 30al on the corner portion 200a of the end surface electrode layer 30a, and the end portion 31a3 on the corner portion 210a of the peripheral surface electrode layer 31a overlaps the end portion 30a2 on the corner portion 210a of the end surface electrode layer 30a. Therefore, the thickness of the external electrode 3a on the corner portions 200a and 210a is increased as compared with the case where the peripheral surface electrode layer 31a and the end surface electrode layer 30a are not overlapped with each other.

On the upper surface 2C, the peripheral surface electrode layer 31b extends to the corner portion 200b from an end portion 2Cb, in the length direction, of the upper surface 2C. In the length direction, the end portion 31b1 of the peripheral surface electrode layer 31b is located on the corner portion 200b, and the end portion 31b2 of the peripheral surface electrode layer 31b is located on the end portion 2Cb, in the length direction, of the upper surface 2C. The peripheral surface electrode layer 31b covers the end surface electrode layer 30b in the corner portion 200b.

On the lower surface 2D, the peripheral surface electrode layer 31b extends to the corner portion 210b from an end portion 2Db, in the length direction, of the lower surface 2D. In the length direction, the end portion 31b3 of the peripheral surface electrode layer 31b is located on the corner portion 210b, and the end portion 31b4 of the peripheral surface electrode layer 31b is located on the end portion 2Db, in the length direction, of the lower surface 2D. The peripheral surface electrode layer 31b covers the end surface electrode layer 30b in the corner portion 210b.

Thus, the end portion 31b1 on the corner portion 200b of the peripheral surface electrode layer 31b overlaps the end portion 30b1 on the corner portion 200b of the end surface electrode layer 30b, and the end portion 31b3 on the corner portion 210b of the peripheral surface electrode layer 31b overlaps the end portion 30b2 on the corner portion 210b of the end surface electrode layer 30b. Therefore, the thickness of the external electrode 3b on the corner portions 200b and 210b is increased as compared with the case where the peripheral surface electrode layer 31b and the end surface electrode layer 30b are not overlapped with each other.

As illustrated in FIG. 4, on the side surface 2E, the peripheral surface electrode layer 31a extends to the corner portion 400a from an end portion 2Ea, in the length direction, of the side surface 2E. In the length direction, an end portion 31a5 of the peripheral surface electrode layer 31a is located on the corner portion 400a, and an end portion 31a6 of the peripheral surface electrode layer 31a is located on the end portion 2Ea, in the length direction, of the side surface 2E. The peripheral surface electrode layer 31a covers the end surface electrode layer 30a in the corner portion 400a.

On the side surface 2F, the peripheral surface electrode layer 31a extends to the corner portion 410a from an end portion 2Fa, in the length direction, of the side surface 2F. In the length direction, an end portion 31a7 of the peripheral surface electrode layer 31a is located on the corner portion 410a, and an end portion 31a8 of the peripheral surface electrode layer 31a is located on the end portion 2Fa, in the length direction, of the side surface 2F. The peripheral surface electrode layer 31a covers the end surface electrode layer 30a at the corner portion 410a.

Thus, the end portion 31a5 on the corner portion 400a of the peripheral surface electrode layer 31a overlaps the end portion 30a3 on the corner portion 400a of the end surface electrode layer 30a, and the end portion 31a7 on the corner portion 410a of the peripheral surface electrode layer 31a overlaps the end portion 30a4 on the corner portion 410a of the end surface electrode layer 30a. Therefore, the thickness of the external electrode 3a on the corner portions 400a and 410a is increased as compared with the case where the peripheral surface electrode layer 31a and the end surface electrode layer 30a are not overlapped with each other.

On the side surface 2E, the peripheral surface electrode layer 31b extends to the corner portion 400b from an end portion 2Eb, in the length direction, of the side surface 2E. In the length direction, the end portion 31b5 of the peripheral surface electrode layer 31b is located on the corner portion 400b, and the end portion 31b6 of the peripheral surface electrode layer 31b is located on the end portion 2Eb, in the length direction, of the side surface 2E. The peripheral surface electrode layer 31b covers the end surface electrode layer 30b in the corner portion 400b.

On the side surface 2F, the peripheral surface electrode layer 31b extends to the corner portion 410b from an end portion 2Fb, in the length direction, of the side surface 2F. In the length direction, the end portion 31b7 of the peripheral surface electrode layer 31b is located on the corner portion 410b, and the end portion 31b8 of the peripheral surface electrode layer 31b is located on the end portion 2Fb, in the length direction, of the side surface 2F. The peripheral surface electrode layer 31b covers the end surface electrode layer 30b in the corner portion 410b.

Thus, the end portion 31b5 on the corner portion 400b of the peripheral surface electrode layer 31a overlaps the end portion 30b3 on the corner portion 400b of the end surface electrode layer 30b, and the end portion 31b7 on the corner portion 410b of the peripheral surface electrode layer 31b overlaps the end portion 30b4 on the corner portion 410b of the end surface electrode layer 30b. Therefore, the thickness of the external electrode 3b on the corner portions 400b and 410b is increased as compared with the case where the peripheral surface electrode layer 31b and the end surface electrode layer 30b are not overlapped with each other.

In each of the corner portions 200a, 210a, 200b, 210b, 400a, 410a, 400 and 410b, the peripheral surface electrode layers 31a and 31b are overlapped with the end surface electrode layers 30a and 30b, respectively, so that each thickness of the external electrodes 3a and 3b is sufficiently secured. Therefore, the moisture resistance of the multilayer ceramic capacitor 1 is improved, and the penetration of the plating solution is suppressed.

Even when the end surface electrode layers 30a and 30b are thin, each thickness of the external electrodes 3a and 3b at the corner portions 200a, 210a, 200b, 210b, 400a, 410a, 400b, and 410b can be sufficiently secured by increasing each thickness of the end portions 31a1, 31a3, 31b1, 31b3, 31a5, 31a7, 31b5, and 31b7 of the peripheral surface electrode layers 31a and 31b. Therefore, the capacitance of the multilayer ceramic capacitor 1 can be increased by increasing the volume of the multilayer body 2 in the length direction by the amount of the reduction in the thickness of the end surface electrode layers 30a and 30b.

Therefore, the capacitance can be improved while ensuring the reliability of the multilayer ceramic capacitor 1.

The plating layer 32a covers the end surface electrode layer 30a and the peripheral surface electrode layer 31a, and the plating layer 32b covers the end surface electrode layer 30b and the peripheral surface electrode layer 31b. Therefore, the moisture resistance of the multilayer ceramic capacitor 1 is further improved. The plating layers 32a and 32b are formed of, for example, copper, nickel, or the like.

The end surface electrode layers 30a and 30b and the peripheral surface electrode layers 31a and 31b may contain glass frit to enhance the bonding strength to the multilayer body 2 when they are fired after the multilayer body 2 is fired. The glass frit is an example of a glass component. When the content of the glass frit in the peripheral surface electrode layers 31a and 31b is set to be higher than the content of the glass frit in the end surface electrode layers 30a and 30b, the barrier function of the glass frit can be enhanced in the upper surface 2C, the lower surface 2D, and the side surfaces 2E and 2F, and an increase in the thickness of the end surface electrode layers 30a and 30b the due to glass frit can be suppressed. For example, the content of the glass frit is defined as the ratio of the area occupied by the glass frit to the area of the end surface electrode layers 30a and 30b, and the ratio of the area occupied by the glass frit to the area of the peripheral surface electrode layers 31a and 31b, in a cross-sectional view as illustrated in FIG. 2 or 4.

In addition, when the main component of the end surface electrode layers 30a and 30b is nickel and the main component of the peripheral surface electrode layers 31a and 31b is copper, the end surface electrode layer 30a and the end surface electrode layer 30b not only have good contact properties with the internal electrode layer 23 when being co-sintered with the dielectric layer 22 at a high temperature, but also can make the external electrodes 3a and 3b thin and dense, and the peripheral surface electrode layers 31a and 31b can suppress infiltration of a plating solution or moisture into the dielectric layer 22, which might decrease reliability due to the inclusion of glass frit. When the main component of each of the end surface electrode layers 30a and 30b and the peripheral surface electrode layers 31a and 31b is copper, the end surface electrode layers 30a and 30b ensure the contact property with the internal electrode layer 23 by increasing the content of copper, and the peripheral surface electrode layers 31a and 31b can suppress the infiltration of a plating solution or moisture into the dielectric layer 22, which might decrease reliability due to the inclusion of glass frit. Thus, the configuration of the end surface electrode layers 30a and 30b and the peripheral surface electrode layers 31a and 31b can provide two effects that are contradictory to each other and might not be obtained by a normal method.

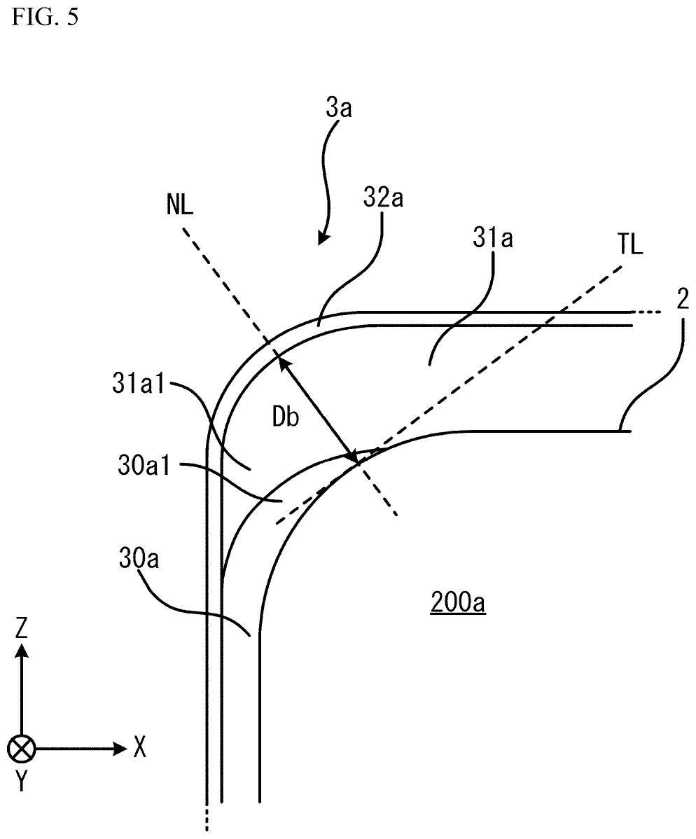

FIG. 5 is a cross-sectional view illustrating an example of the thickness Db of the external electrode 3a in the corner portion 200a at the upper surface 2C and the end surface 2A of the multilayer body 2. In FIG. 5, the same reference numerals are given to the same components as those in FIG. 2, and the description thereof will be omitted.

The thickness Db of the external electrode 3a in the present example is the thickness of the end surface electrode layer 30a and the peripheral surface electrode layer 31a that overlap each other on the corner portion 200a. That is, the thickness Db is the total thickness of the end portion 30al of the end surface electrode layer 30a and the end portion 31al of the peripheral surface electrode layer 31a.

In detail, the thickness Db is defined as a maximum value of a length of a normal line NL extending from the surface of the corner portion 200a to the plating layer 32a in a cross section along the lamination direction and the length direction. Here, the normal line NL is a straight line that is orthogonal to a tangent line TL that is in contact with a point on the surface of the corner portion 200a and passes through the point.

On the other hand, as illustrated in FIG. 2, the thickness Da of the end surface electrode layer 30a is defined as a size in the length direction at a position (T/2) of half the height T of the multilayer body 2 in the lamination direction. When the thickness Da of the central portion of the end surface electrode layer 30a in the lamination direction is equal to or less than the thickness Db of the corner portion 200a, the size of the multilayer body 2 in the length direction is able to be increased, and the capacitance is able to be increased while reliability is ensured by the thickness Db of the corner portion 200a. More preferably, thickness Da of the end surface electrode layer 30a may be not more than 0.5 times thickness Db of the corner portion 200a.

Although the end surface electrode layer 30a and the peripheral surface electrode layer 31a on the corner portion 200a are described in this example, the ratio of the thicknesses Da and Db is the same as described above for the end surface electrode layer 30a and the peripheral surface electrode layer 31a on the corner portion 210a on the lower surface 2D. In addition, although the end surface electrode layer 30a and the peripheral surface electrode layer 31a are described in this example, the ratio of the thicknesses Da and Db is the same as described above for the end surface electrode layer 30b and the peripheral surface electrode layer 31b.

### (Step of Manufacturing Multilayer Ceramic Capacitor)

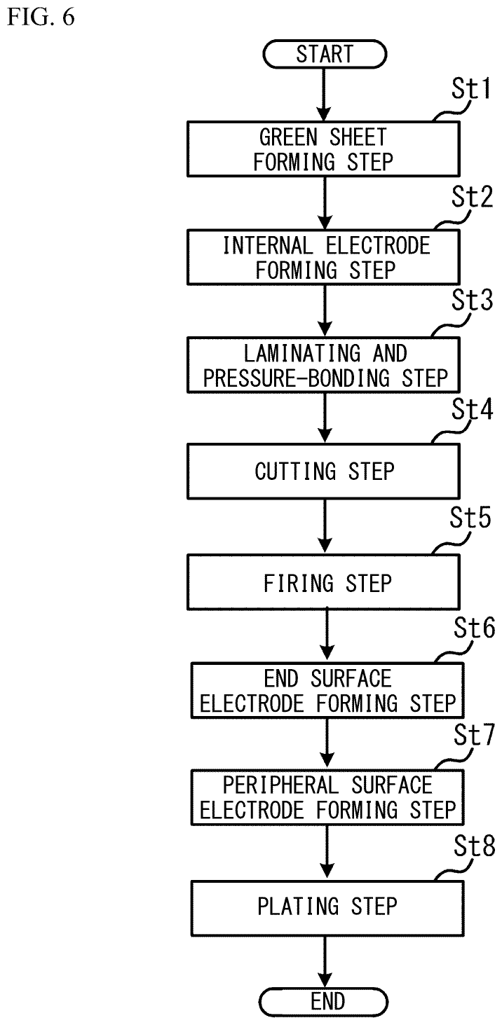

FIG. 6 is a flowchart illustrating an example of a manufacturing process of the multilayer ceramic capacitor 1. This manufacturing process is an example of a method of manufacturing a multilayer ceramic electronic component.

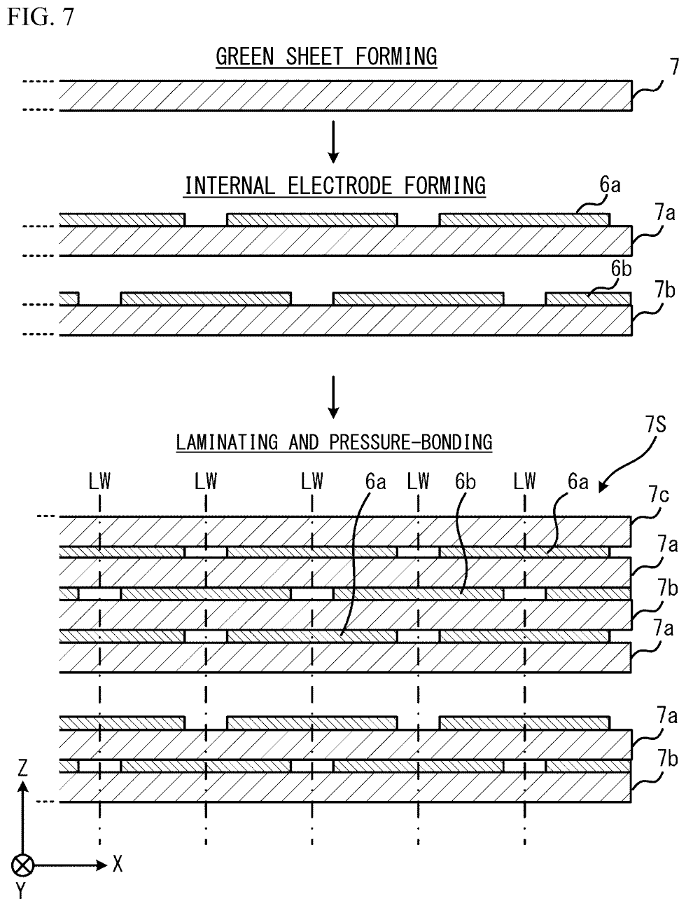

FIG. 7 is a plan view illustrating an example of a green sheet forming step St1, an internal electrode forming step St2, and a laminating and pressure-bonding step St3. The manufacturing process will be described below with reference to FIGS. 6 and 7. Note that FIG. 7 illustrates an X axis, a Y axis, and a Z axis similar to those in FIGS. 1 to 5.

### (Green Sheet Molding Step)

First, a green sheet molding step St1 is performed. In this step, for example, a binder such as a polyvinyl butyral (PVB) resin, an organic solvent such as ethanol or toluene, and a plasticizer are added to a dielectric material obtained by adding various additive compounds (sintering aid, and so on) to a ceramic powder, and the mixture is wet-mixed. The obtained slurry is used to coat a dielectric green sheet on a base material by, for example, a die coater method or a doctor blade method, and the dielectric green sheet is dried. The base material is, for example, a PET (polyethylene terephthalate) film.

Mg (magnesium), Mn (manganese), V (vanadium), Cr (chromium), oxides of rare earth elements (Y (yttrium), Sm (samarium), Eu (europium), Gd (gadolinium), Tb (terbium), Dy (dysprosium), Ho (holmium), Er (erbium), Tm (thulium), and Yb (ytterbium)), and oxides of Co (cobalt), Ni, Li (lithium), B (boron), Na (sodium), K (potassium), and Si (silicon) or glass is used as the additive compound of the ceramic powder.

### (Internal Electrode Forming Step)

Next, an internal electrode forming step St2 is performed. In this step, the conductive paste to which ceramic particles are added is applied to the surfaces of dielectric green sheets 7a and 7b of dielectric green sheets 7, thereby forming the internal electrode patterns 6a and 6b. The internal electrode patterns 6a and 6b each has a shape corresponding to the internal electrode layer 23. To be specific, the internal electrode patterns 6a and 6b are formed so as to be shifted from each other by a half pitch in the X axis direction.

In this step, the conductive paste containing a metal for forming internal electrode containing an organic binder is printed on the dielectric green sheets 7a and 7b on the base material by gravure printing or the like, thereby forming the plurality of internal electrode patterns 6a and 6b spaced apart from each other. The ceramic particles are added to the conductive paste as a co-fired material. The main component of the ceramic particles is not particularly limited, but is preferably the same as the main component ceramic of the dielectric layer 22. Additionally, the method of forming the internal electrode patterns 6a and 6b is not limited to printing, and a vacuum film formation method such as sputtering may be used.

### (Laminating and Pressure-Bonding Step)

Next, a laminating and pressure-bonding process St3 is performed. In this step, a plurality of dielectric green sheets 7a and 7b on which the internal electrode patterns 6a and 6b to be the internal electrode layers 23 are printed, and a dielectric green sheet 7c on which the internal electrode patterns are not printed are laminated and pressure-bonded to form a laminated sheet 7S. In this case, the dielectric green sheets 7a and 7b are alternately laminated in a lamination direction so that the internal electrode patterns 6a and 6b are alternately drawn out, and the dielectric green sheet 7c is laminated on the plurality of dielectric green sheets 7a and 7b.

At the time of pressure-bonding, the dielectric green sheets 7a and 7b are laminated so that the internal electrode patterns 6a and 6b face each other with the dielectric green sheets 7a and 7b interposed therebetween. The plurality of laminated dielectric green sheets 7a to 7c are pressed to pressure-bond the dielectric green sheets 7a to 7c to each other. The pressure-bonding means may be, for example, a hydrostatic press, but is not limited thereto.

### (Cutting Step)

Next, a cutting step St4 is performed. In this step, the multilayer sheet 7S obtained by the pressure-bonding is divided into a plurality of multilayer bodies each having a substantially rectangular parallelepiped shape. For example, a plurality of unfired multilayer bodies are obtained by cutting the multilayer sheet in the lamination direction along predetermined cut lines LW with a blade.

### (Firing Step)

Next, a firing step St5 is performed. In this step, the multilayer body is subjected to a binder removal treatment in a N₂ atmosphere at 250 to 500° C., and then fired at a firing temperature of 1200° C. or higher for about 1 hour in a reduction atmosphere with a partial pressure of oxygen of 0.003 (Pa), whereby the particles in the multilayer body are sintered. As a result, in the multilayer body, the dielectric green sheets 7a and 7b become the side margins 40 and 41, and the dielectric layers 22, the dielectric green sheets 7c and 7b become the cover layers 20 and 21, and the internal electrode patterns become the internal electrode layers 23.

A series of steps from the green sheet forming step St1 to the firing step St5 is an example of a step of forming the multilayer body 2. After that, the external electrodes 3a and 3b are formed. The external electrodes 3a and 3b may be fired simultaneously with the multilayer body 2.

### (End Surface Electrode Forming Step)

First, an end surface electrode forming step St6 is performed. The end surface electrode forming step St6 is an example of a step of forming the end surface electrode layers 30a and 30b. In this step, the end surface electrode layers 30a and 30b are formed on the end surfaces 2A and 2B of the multilayer body 2, respectively. The end surface electrode layers 30a and 30b may be formed by, for example, attaching a metal sheet to the end surfaces 2A and 2B and firing the metal sheet.

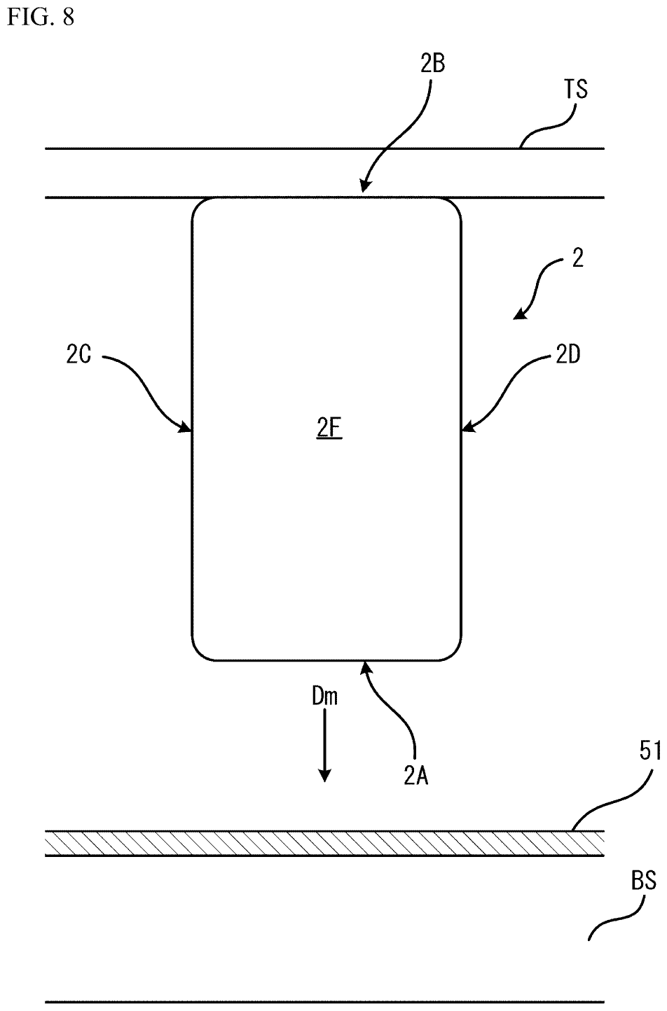

FIGS. 8 to 10 are side views illustrating an example of the end surface electrode forming step St6 when the end surface 2A of the multilayer body 2 is viewed from the front. In this example, the step of forming the end surface electrode layer 30a on the end surface 2A is described, but the step of forming the end surface electrode layer 30b on the end surface 2B is the same.

First, as illustrated in FIG. 8, a metal sheet 51 is disposed on a plate surface of an elastic body BS having a flat plate shape. The metal sheet 51 is mainly composed of, for example, nickel or copper. In addition, the end surface 2B of the multilayer body 2 is fixed on a tape TS, and the multilayer body 2 is disposed above the metal sheet 51 so that the end surface 2A faces a front surface of the metal sheet 51. Note that FIGS. 8 to 10 illustrate the cross sections of the metal sheet 51 along the side surfaces 2E and 2F of the multilayer body 2.

Next, the tape TS is moved downward by a pressing device (not illustrated). As a result, the multilayer body 2 moves toward the metal sheet 51 as indicated by a reference sign Dm. After the movement, the end surface 2A of the multilayer body 2 is brought into contact with the metal sheet 51.

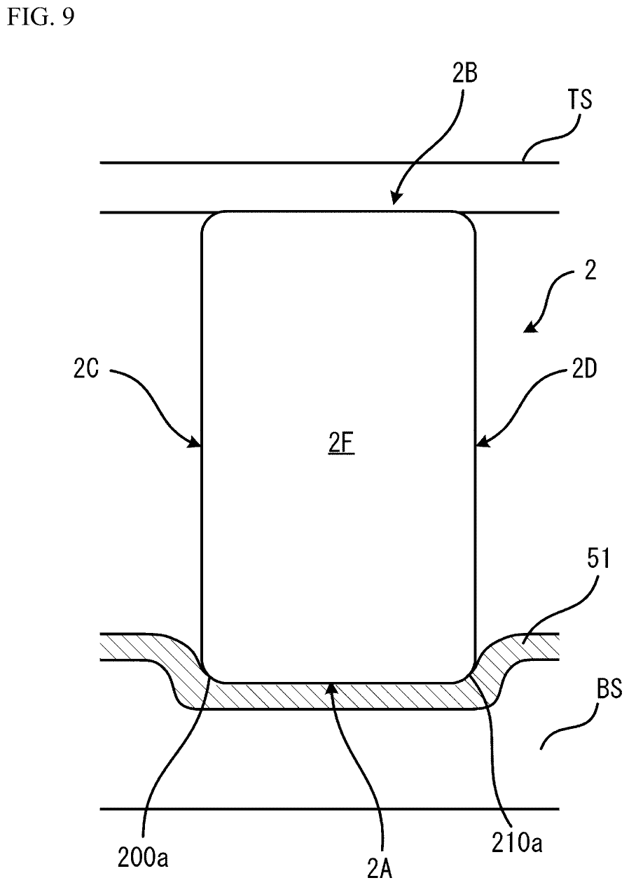

As a result, as illustrated in FIG. 9, the end surface 2A of the multilayer body 2 is pressed against the surface of the metal sheet 51. At this time, the corner portions 200a and 210a of the multilayer body 2 are also in contact with the surface of the metal sheet 51. Therefore, the surface of the metal sheet 51 is adhered to the end surface 2A of the multilayer body 2 and the corner portions 200a and 210a adjacent thereto. Similarly, the corner portions 400a and 410a of the multilayer body 2 are also brought into contact with the surface of the metal sheet 51 and are adhered thereto. Thus, the metal sheet 51 covers the surface of the multilayer body 2 from the end surface 2A to the four corner portions 200a, 210a, 400a, and 410a.

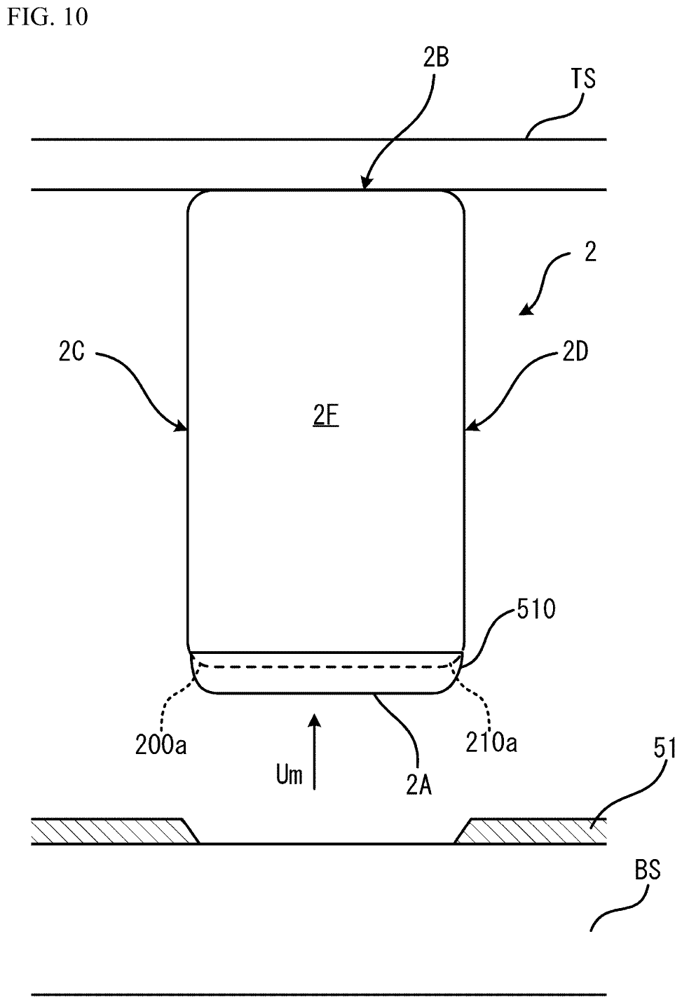

Next, as illustrated in FIG. 10, the tape TS is moved upward by the pressing device (not illustrated). As a result, the multilayer body 2 moves away from the elastic body BS as indicated by a reference sign Um. At this time, a part of a metal sheet 510 is cut off from the metal sheet 51 while being adhered to the end surface 2A and the corner portions 200a, 210a, 400a, and 410a of the multilayer body 2. The metal sheet 510 adhered to the end surface 2A is formed as the end surface electrode layer 30a after firing. The end surface electrode layer 30b is also formed by attaching a metal sheet in the same process as described above.

### (Peripheral Surface Electrode Forming Step)

Referring again to FIG. 6, after the end surface electrode forming step St6, a peripheral surface electrode forming step St7 is performed. The peripheral surface electrode forming step St7 is an example of a step of forming the peripheral surface electrode layer 31a by applying a conductive paste to the multilayer body 2. In this step, the conductive paste is applied to the multilayer body 2 by, for example, a dipping method. The conductive paste contains, for example, copper as a main component.

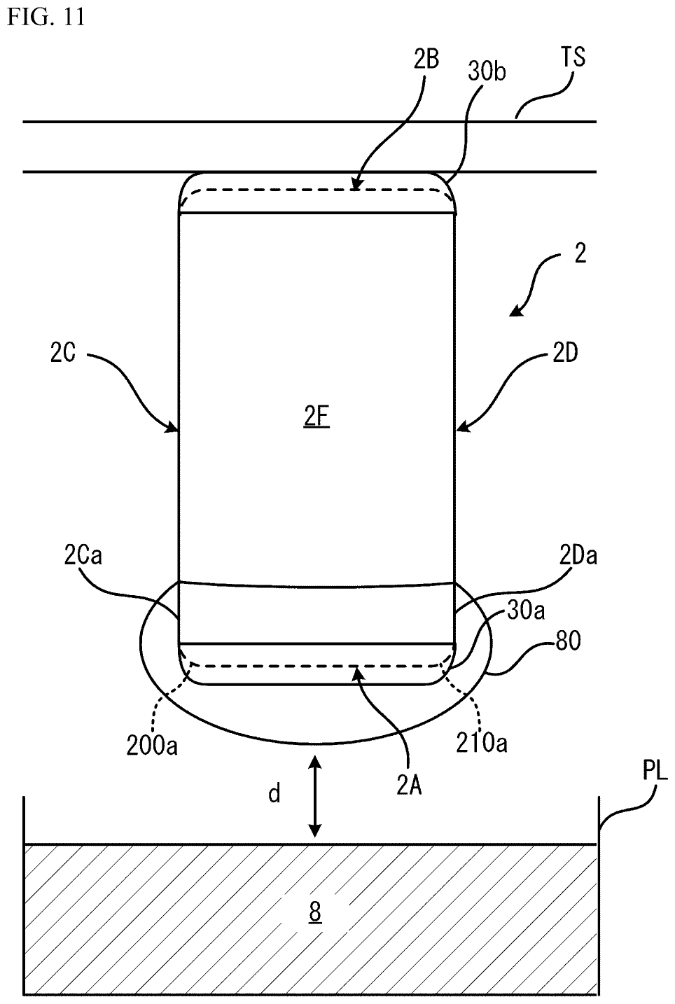

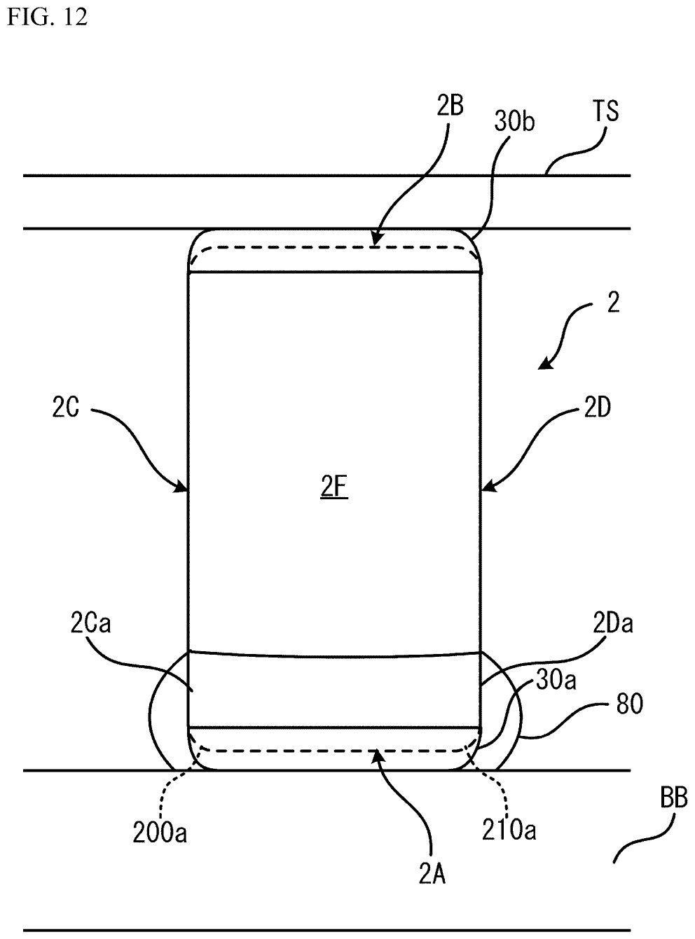

FIGS. 11 and 12 are plan views illustrating an example of the peripheral surface electrode forming step St7 by the dipping method in a side view of the multilayer body 2. Dotted lines indicate an outer shape of the end portion of the multilayer body in the length direction.

Referring to FIG. 11, the multilayer body 2 having the end surface electrode layers 30a and 30b is dipped in a reservoir PL of a conductive paste 8 with the end surface 2B adhered to the tape TS, and then pulled up from the reservoir PL, as indicated by an arrow d. Thus, a conductive paste 80 is applied to the multilayer body 2 so as to cover the end surface electrode layer 30a. At this time, the conductive paste 80 has a substantially spherical shape and covers, in the length direction of the multilayer body 2, a region from the end surface electrode layer 30a to the end portions 2Ca, 2Da, 2Ea, and 2Fa in the length direction of the upper surface 2C, the lower surface 2D, the side surfaces 2E and 2F.

Next, referring to FIG. 12, the shape of the conductive paste 80 applied to the multilayer body 2 is adjusted by blotting. In blotting, the tape TS is moved toward the board BB, and the end surface 2A is pressed against the board BB in a state where the end surface electrode layer 30a of the multilayer body 2 is opposed to a front surface of the board BB. Thus, the conductive paste 80 applied to the end surface electrode layer 30a is removed from the surface substantially parallel to the end surface 2A. As a result, the conductive paste 80 remains only on the corner portions 200a and 210a, and the end portions 2Ca, 2Da, 2Ea, and 2Fa in the respective length direction of the upper surface 2C, the lower surface 2D, and the side surfaces 2E and 2F. The conductive paste 80 on the corner portion 200a and 210a covers the end surface electrode layer 30a (the metal sheet 510).

In this manner, the conductive paste 80 is applied so as to extend from the end portions 2Ca, 2Da, 2Ea, and 2Fa in the respective length direction of the upper surface 2C, the lower surface 2D, and the side surfaces 2E and 2F to the corner portions 200a, 210a, 400a, and 410a, and covers the end surface electrode layer 30a in the corner portions 200a, 210a, 400a, and 410a. Thereafter, the conductive paste 80 is dried to volatilize the solvents and contract in volume, and is fired on the multilayer body 2 to form the peripheral surface electrode layer 31a. The peripheral surface electrode layer 31b is also formed by applying the conductive paste 80 to the end surface 2B of the multilayer body 2 by the dipping method in the same manner as described above.

### (Plating Step)

Referring again to FIG. 6, after the peripheral surface electrode forming step St7, a plating step St8 is performed. In this step, the plating layers 32a and 32b are formed by, for example, electrolytic plating so as to cover the end surface electrode layers 30a and 30b and the peripheral surface electrode layers 31a and 31b, respectively. In this example, copper plating is used, but the plating is not limited thereto, and plating may be performed with other metals. The multilayer ceramic capacitor 1 is manufactured in this manner.

In the above-described manufacturing process, the end surface electrode layer 30a and 30b and the peripheral surface electrode layers 31a and 31b may be fired on the multilayer body 2 at the same time, but may be fired separately in the end surface electrode forming process St6 and the peripheral surface electrode forming process St7. In this case, the firing temperatures of the end surface electrode forming step St6 and the peripheral surface electrode forming step St7 can be individually adjusted. For example, in the end surface electrode forming step St6, the firing temperature is set to be lower than that in the peripheral surface electrode forming step St7, so that the occurrence of cracks in the multilayer body 2 can be suppressed. In addition, in the peripheral surface electrode forming step St7, the sintering temperature is set to be higher than that in the end surface electrode forming step St6, so that the diffusion of the glass frit in the metal sheet 510 can be promoted. The end surface electrode layer 30a and 30b may be fired simultaneously with the multilayer body 2.

When the end surface electrode layer 30a and 30b and the peripheral surface electrode layers 31a and 31b are both mainly composed of copper and are simultaneously fired on the multilayer body 2, in a cross-sectional view of the multilayer ceramic capacitor 1 as a completed product, the boundaries between the end surface electrode layer 30a and 30b and the peripheral surface electrode layers 31a and 31b can be recognized by scanning electron microscopy or by energy dispersive X-ray spectrometry (EDS) analysis, after exposing the cross sections near the external electrodes 3a and 3b by polishing or the like. According to this method, it is possible to confirm a difference in the distribution state of Cu particles due to a difference in the formation method. Even when the end surface electrode layers 30a and 30b and the peripheral surface electrode layers 31a and 31b contain different additive components, the composition analyzed results are different in each region of the cross section, so the boundaries between the end surface electrode layers 30a and 30b and the peripheral surface electrode layers 31a and 31b can be recognized.

The above embodiments are merely examples for carrying out the present disclosure, and the present disclosure is not limited to these embodiments. It is to be understood that the various change, substitutions, and alterations could be made hereto without departing from the spirit and scope of the invention.

What is claimed is:

1. A multilayer ceramic electronic component comprising:
a multilayer body that has a substantially rectangular parallelepiped shape and includes a plurality of internal electrode layers and a plurality of dielectric layers laminated on each other, the plurality of internal electrode layers being led out to a pair of end surfaces facing each other in a direction substantially orthogonal to a lamination direction of the plurality of internal electrode layers and the plurality of dielectric layers;
a pair of end surface electrode layers that covers the pair of end surfaces so as to be connected to the plurality of internal electrode layers and extends from the pair of end surfaces to a pair of corner portions between the pair of end surfaces and four surfaces other than the pair of end surfaces among six surfaces of the multilayer body; and
a peripheral surface electrode layer that extends from end portions, in the substantially perpendicular direction, of the four surfaces other than the pair of end surfaces among the six surfaces of the multilayer body to the corner portions and covers the end surface electrode layers at the corner portions.

2. The multilayer ceramic electronic component according to claim 1, wherein
the peripheral surface electrode layer has a higher glass component content than the end surface electrode layer.

3. The multilayer ceramic electronic component according to claim 1, wherein
the end surface electrode layer contains nickel as a main component, and
the peripheral surface electrode layer contains copper as a main component.

4. The multilayer ceramic electronic component according to claim 1, wherein
the end surface electrode layer and the peripheral surface electrode layer contain copper as a main component.

5. The multilayer ceramic electronic component according to claim 1, wherein
in a cross-sectional view of the multilayer body along the lamination direction and the substantially orthogonal direction, a thickness of a central portion of the end surface electrode layer in the lamination direction is equal to or less than a maximum value of a thickness of the end surface electrode layer and the peripheral surface electrode layer overlapping each other on the corner portion.

6. A method of manufacturing a multilayer ceramic electronic component, comprising:
forming a multilayer body having a substantially rectangular parallelepiped shape and including a plurality of internal electrode layers and a plurality of dielectric layers laminated on each other, the plurality of internal electrode layers being alternately led out along a lamination direction to a pair of end surfaces facing each other;
forming a pair of end surface electrode layers connected to the plurality of internal electrode layers by attaching a metal sheet from the pair of end surfaces to a pair of corner portions between the pair of end surfaces and four surfaces other than the pair of end surfaces among six surfaces of the multilayer body; and
forming a peripheral surface electrode layer by applying a conductive paste to the multilayer body such that the conductive paste extends from end portions, in the substantially orthogonal direction, of the four surfaces other than the pair of end surfaces among the six surfaces of the multilayer body to the corner portions and covers the end surface electrode layers at the corner portions.

7. The method of manufacturing the multilayer ceramic electronic component according to claim 6, wherein
the metal sheet contains nickel as a main component, and
the conductive paste contains copper as a main component.

8. The method of manufacturing the multilayer ceramic electronic component according to claim 6, wherein the metal sheet and the conductive paste contain copper as a main component.

9. The method of manufacturing the multilayer ceramic electronic component according to claim 8, wherein
the forming of the pair of end surface electrode layers includes attaching and firing the metal sheet, and
the forming of the peripheral surface electrode layer includes applying the conductive paste to the multilayer body and firing the conductive paste.
